(19) United States
(12) Patent Application Publication
(10) Pub. No.: US 2015/0237875 A1
(43) Pub. Date: Aug. 27, 2015

(54) ALCOHOLIC CUPCAKE PREPARATION METHODS

(71) Applicant: Autumn Marie Skoczen, Broadview Hts, OH (US)

(72) Inventor: Autumn Marie Skoczen, Broadview Hts, OH (US)

(21) Appl. No.: 14/191,004

(22) Filed: Feb. 26, 2014

(51) Int. Cl. A21D 8/06

(52) U.S. Cl. CPC A21D 8/06

(57) ABSTRACT

A method of baking alcohol infused cupcakes is provided. The cupcakes may be at least partially baked and then dehydrated. A user may then inject alcohol into the dehydrated cupcake. The cupcakes may be chilled and then eaten.

### BACKGROUND OF THE INVENTION

The present invention relates to preparation methods for cupcakes, and more particularly to preparation methods of alcoholic cupcakes.

Currently, alcohol based treats are popular. For example, bakers may mix alcohol with batter prior to baking baked goods. However, the integrity of alcohol is destroyed when placed within a cupcake prior to baking. Alcohol will burn or eat-away at sugars, lowering the content level of the alcohol. Therefore, a baker may place alcohol into a secondary medium such as icing, jams/jellies, puddings, butters, creams, chocolates, batter and the like.

As can be seen, there is a need for a method of baking alcohol infused baked goods that retains a high alcohol level.

### SUMMARY OF THE INVENTION

In one aspect of the present invention, a method of preparing baked goods comprises: baking the baked goods until the baked goods are at least partially cooked; and injecting an inside of the baked goods with a liquid alcohol.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is a detailed section view of the present invention taken along line 2-2 in FIG. 1; and

FIG. 3 is a flowchart of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of baking alcohol infused cupcakes. The cupcakes may be at least partially baked and then dehydrated. A user may then inject alcohol into the dehydrated cupcake. The cupcakes may be chilled and then eaten. The present invention may include a variable of cupcakes filled with alcohol after the baking process. The present invention puts the alcohol into the cupcakes after baking to keep the integrity of the alcohol, and prevent the cupcake(s) from falling apart.

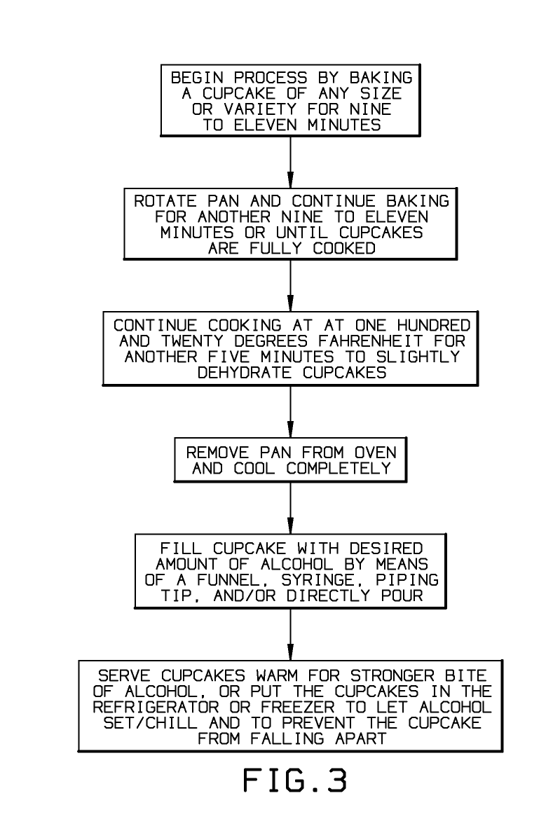

Referring to FIGS. 1 through 3, the present invention may include the following method steps. A method of preparing baked goods may include baking the baked goods until the baked goods are at least partially cooked and injecting an inside of the baked goods with a liquid alcohol. When partially baking the baked goods, the baked goods may be fully cooked after injecting the baked goods with a liquid alcohol.

In certain embodiments, the baked goods may be fully cooked prior to the injection of the inside of the baked goods with the liquid alcohol. In such embodiments, the baked goods may be at least partially dehydrated after the baked goods have been fully cooked. Further, the present invention may include allowing the baked goods to cool after dehydrating the baked goods. Once the baked goods have cooled, the alcohol may be injected into the baked goods.

The baked goods may be any baked goods, including but not limited to, cupcakes, brownies, donuts, cakes, and cake pops. When the baked goods are cupcakes, the cupcakes may be baked at a temperature of at least about 120° F. to about 175° F. for about 9 to about 11 minutes. The cupcakes may then be rotated and again baked at a temperature of at least about 120° F. to about 175° F. for about 9 to about 11 minutes. The cooking times for each individual cupcake recipe may be longer or shorter than 9-11 minutes depending on the ingredients, batter consistency or general cooking guidelines. The cupcakes may be at least partially dehydrated by leaving the cupcakes at a temperature of about 120° F. for at least an additional 5 minutes. The dehydration step may dehydrate the cupcakes without burning the cupcakes. The cooking and or dehydration process can be achieved using ovens, dehydrators, stoves, microwaves, open/closed flames or any other suitable device.

As mentioned above, the alcohol may be injected into the baked goods after the baked goods have been at least partially cooked. The alcohol may replace the moisture within the baked goods. In certain embodiments, injecting the inside of the baked goods with a liquid alcohol may include puncturing the baked goods and pouring in alcohol. The baked goods may be punctured by at least one of a syringe, a funnel, a piping tip and a utensil. When a funnel is used, an alcohol bottle may directly pour the alcohol into the funnel and into the baked goods. In certain embodiments, alcohol infused fruit may be injected into the baked goods.

In certain embodiments, the present invention may include the step of refrigerating or freezing the baked goods after the alcohol has been injected. Chilling the cupcakes once the alcohol has been injected allows for the alcohol to chill and set. This helps keep the cupcake from falling apart when eaten. However, the cupcakes may be served without chilling the cupcakes for a stronger taste.

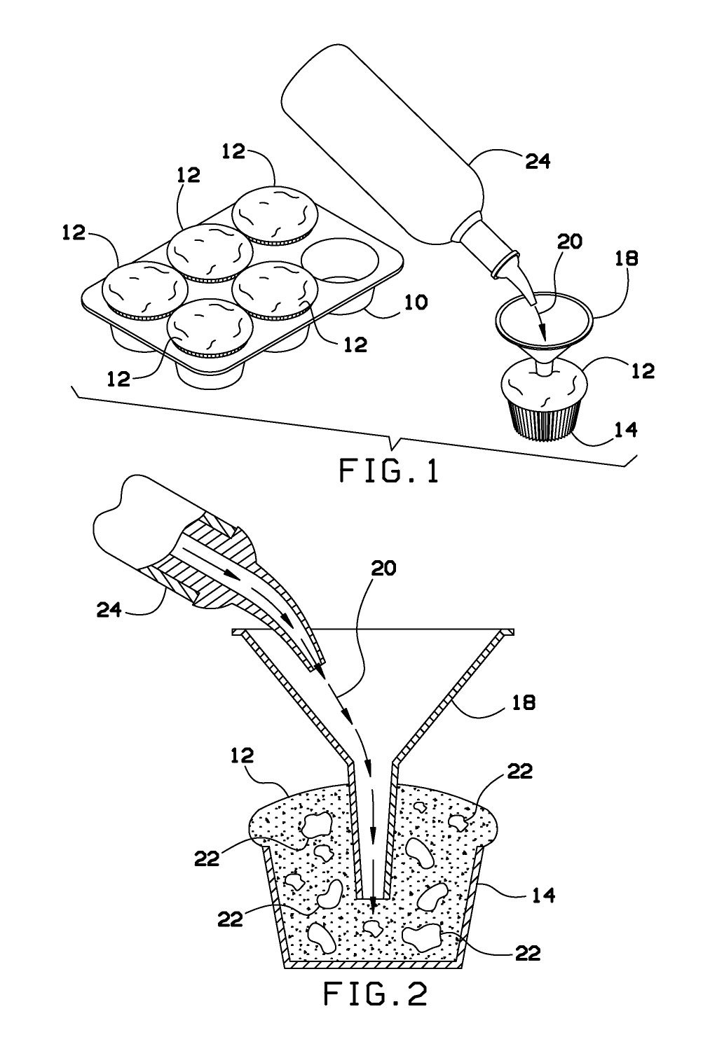

As illustrated in FIGS. 1 and 2, the components of the present invention may include a cupcake baking pan 10. The cupcakes 12 may be baked within a paper cup 14 using the cupcake baking pan 10 until fully cooked. The cupcake baking pan 10 may be removed from an oven and a funnel 18 may be inserted through the surface of the cupcakes 12. A user may pour alcohol 20 from an alcohol bottle 24 into the funnel 18. The alcohol 20 may absorb 22 into the cupcake 12.

It should be understood, of course, that the foregoing relates to exemplary embodiments of the invention and that modifications may be made without departing from the spirit and scope of the invention as set forth in the following claims.

What is claimed is:

1. A method of preparing baked goods comprising:
baking the baked goods until the baked goods are at least partially cooked; and
injecting an inside of the baked goods with a liquid alcohol.

2. The method of claim 1, further comprising the step of baking the baked goods until the baked goods are fully cooked after injecting the baked goods with the liquid alcohol.

3. The method of claim 1, wherein the baked goods are fully cooked prior to injecting the inside of the baked goods with the liquid alcohol.

4. The method of claim 3, further comprising the step of at least partially dehydrating the baked goods after the baked goods have been fully cooked.

5. The method of claim 4, further comprising the step of allowing the baked goods to cool after dehydrating the baked goods.

6. The method of claim 4, wherein the baked goods are at least one of cupcakes, brownies, donuts, cakes, and cake pops.

7. The method of claim 6, wherein the baked goods are cupcakes.

8. The method of claim 7, wherein baking the baked goods comprises the steps of:
baking the cupcakes at a temperature of at least about 120° F. to about 175° F. for about 9 to about 11 minutes;
rotating the cupcakes; and
baking the cupcakes at a temperature of at least about 120° F. to about 175° F. for about 9 to about 11 minutes.

9. The method of claim 7, wherein at least partially dehydrating the baked goods comprises the step of:
leaving the cupcakes at a temperature of about 120° F. for at least an additional 5 minutes.

10. The method of claim 1, wherein injecting an inside of the baked goods with a liquid alcohol comprises the step of: puncturing the baked goods and pouring in alcohol.

11. The method of claim 10, wherein the baked goods is punctured by at least one of a syringe, a funnel, and a utensil.

12. The method of claim 1, further comprising the step of refrigerating or freezing the baked goods after the alcohol has been injected.
